(19) United States
(12) Patent Application Publication
(10) Pub. No.: US 2012/0092736 A1
(43) Pub. Date: Apr. 19, 2012

(54) SPECTRUM VIEWING DEVICE AND METHOD

(76) Inventor: Peter Alan Fish, Killara (AU)

(21) Appl. No.: 12/907,542

(22) Filed: Oct. 19, 2010

(51) Int. Cl. G02B 25/02; G02B 5/32; G02B 27/02

(52) U.S. Cl. 359/19; 359/615; 359/801; 359/805

(57) ABSTRACT

A capsule includes a bottom portion for holding a liquid used for making bubbles, and a separate top portion. The top portion can be used to blow bubbles, where the bubble, after at least partially air drying, can be formulated to rest on a surface. The top portion also includes an aperture that houses a hologram lens. After a bubble is blown and at least partially immobilized on a surface, the top portion is placed in an optimal viewing position near the bubble. Viewing of the bubble through the lens of the top portion separates the light reflected off the bubble into a spectrum. The top portion and the bottom portion of the capsule can temporarily be attached to one another by forming a seal, by being temporarily affixed into one another. The top portion and bottom portion of the capsule can also be at least partially separated from each other.

### FIELD OF THE INVENTION

The present application generally relates to a system, apparatus and method for viewing a light spectrum in a polymer-based bubble, where a film is placed on the cap of a container of a bubble solution to form a lens. The viewing of the light spectrum in the bubble creates an effect of at least one “star”-like shape appearing within the bubble when viewing the bubble through the lens held near the bubble.

### BACKGROUND OF THE INVENTION

Children blow ordinary soap bubbles but the bubbles pop, disintegrate and/or deconstruct soon after they are blown. Using the Catch-A-Bubble® formulated bubble liquid, children can catch bubbles in their hands, without the bubbles popping or deconstructing.

In the past, children have used novelty glasses containing specially treated holographic film lenses that break light into its constituent spectral components. However, ordinary soap bubbles when viewed through these holographic lenses cannot produce a significant effect, as ordinary soap bubbles do not deflect light in a manner wherein it can separated into its spectral components. Therefore, viewing ordinary soap bubbles through the lenses of the novelty glasses does not produce any significant results.

Additionally, these ordinary soap bubbles are not formulated to maintain their structure. Since these soap bubbles pop or disintegrate upon contact, they cannot be “caught” by a child. The short existence of these ordinary soap bubbles only gives a child a small time frame to attempt to entrap or even view a light spectrum from a bubble.

Also, a child may not be able to use the novelty glasses to view a clear, non-cloudy light spectrum of the ordinary soap bubble and the novelty glasses may create a safety hazard for a child, since a child running around wearing the glasses and chasing ordinary soap bubbles may not be able to clearly see his/her surroundings and may cause injury to himself/herself or others.

Accordingly, there exists a need for a user, such as a child, to be able to view spectral effects, such as effects that appear to be “star” shaped, apparently within a long-lasting bubble through a lens that can be hand-held, allowing for greater safety than wearing existing novelty glasses.

### SUMMARY OF THE INVENTION

According to one embodiment, a user, such as a child, can use a hand-held hologram lens mounted on a cap to view a separated light spectrum apparently within a long-lasting bubble, such as a bubble produced by using the Catch-A-Bubble® formula.

According to another embodiment, a child can blow a bubble without completely removing the hologram lens cap from the tube container housing the Catch-A-Bubble® formula. This may prevent spilling of the formula and reduces dripping of the formula.

According to yet another embodiment, the hologram lens cap comprises a single unit including a wand, a casing for holding a lens, including hologram film, and a lid. The hologram lens cap can be removably attached onto the container thus creating a single entity that can be held in a child's hand.

These and other features of this invention are described in, or are apparent from, the following detailed description of various exemplary embodiments of this invention.

### BRIEF DESCRIPTION OF THE DRAWINGS

The features and advantages of the present application will be more fully understood with reference to the following detailed description when taken in conjunction with the accompanying figures, wherein:

FIG. 1A is a right front perspective view which illustratively depicts some portions of the assembled hologram lens cap;

FIG. 1B is a right front perspective exploded view which illustratively depicts some portions of the hologram lens cap;

FIG. 2 illustratively depicts the various components of the hologram system including a container for the bubble solution and an assembled hologram lens cap having a wand attached;

FIGS. 3A-3B illustratively depict the various unassembled components of the present system in exploded views;

FIGS. 4A-4B illustratively depict how a user views a light spectrum apparently within a bubble blown by the user; and

FIG. 5 illustratively depicts a user's hand catching several long-lasting blown bubbles.

### DETAILED DESCRIPTION OF THE EXEMPLARY EMBODIMENTS

A system, apparatus and method of viewing a separated light spectrum, apparently within a long-lasting bubble, is provided. The system allows for a user, such as a child, to blow one or more long-lasting bubbles and then hold the bubble(s) in place while looking through a hologram lens cap comprising hologram film. As light reflects off the bubble, the light may be split and diffract into several beams travelling in different directions. This diffraction grating effect created by the hologram film can display a star-like pattern imposed upon the subject matter viewable through the lens. In other words, a child viewing the bubble through the hologram lens cap can see at least one “star” apparently within the bubble.

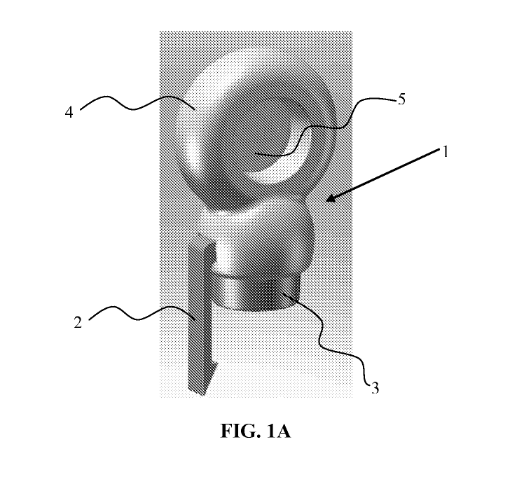

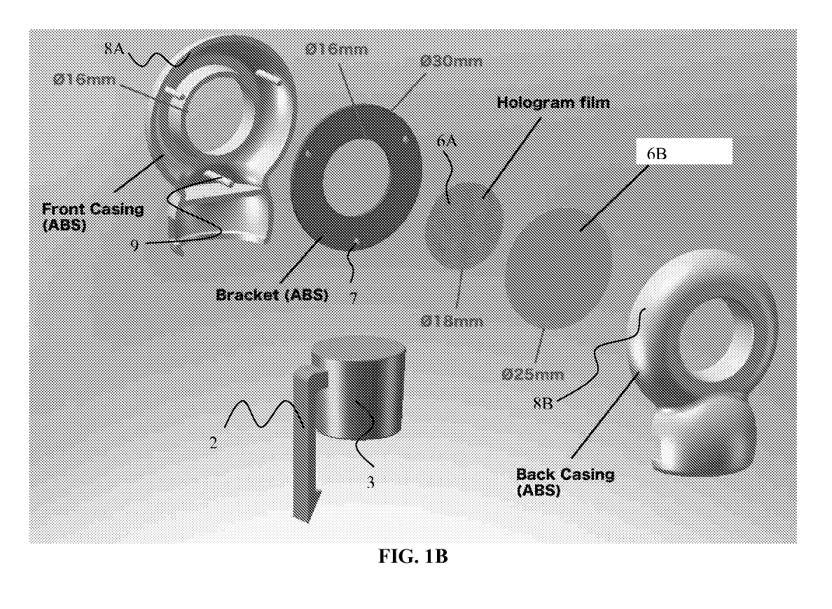

FIG. 1A illustrates a portion of the hologram lens cap 1. The hologram lens cap 1 comprises a clip 2, a lid 3, a casing 4 and a hologram lens 5. The hologram lens will be described in detail below.

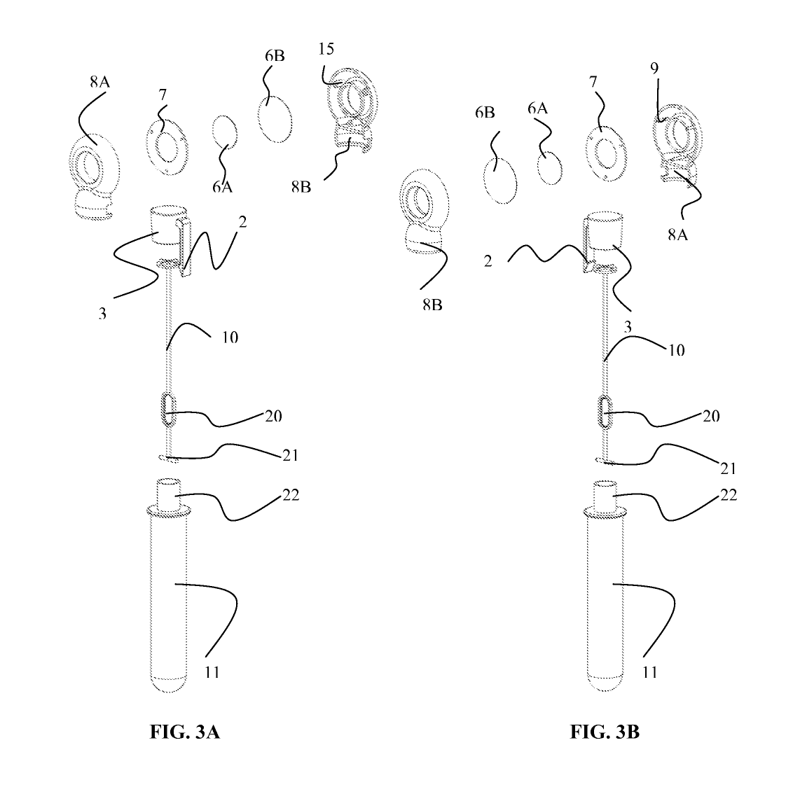

FIG. 1B illustrates details about the various components that make up the hologram lens cap 1. The casing 4, as shown in FIG. 1A, may comprise a front casing 8A and a back casing 8B. In one embodiment, the front casing 8A includes three male prongs 9. The male prongs snap and lock into the three counterpart female sections (labeled as reference numeral 15 in FIG. 3A) inside the back casing 8B. The locking of the prongs into the female sections combines the front and back casings, 8A and 8B, respectively, along with other portions of the hologram lens cap 1 into one, solid cap. In one embodiment of the present application, an adhesive can be applied onto the front and back casings to bond them together and ensure that the pieces do not separate. The casing can be constructed of any reasonable material such as, but not limited to any type of plastic, and/or from any material from an animal source, plant source, mineral source, and synthetic source, and/or any other reasonable source.

Secured in between the front casing 8A and the back casing 8B are a bracket 7, a hologram film 6A, a clear plastic material 6B, a clip 2 and a lid 3. In one embodiment of the present application, the clear plastic material 6B has an adhesive applied to it so that the clear plastic material 6B can bond to the hologram film 6A and the bracket 7. The clear plastic material 6B and the hologram film 6A combined make up the hologram lens 5. In one embodiment of the present application, the hologram lens can be created by photographically embedding a hologram into polymer film and die cut into 1.8 cm circles. The die cut polymer film can then be laminated with the clear plastic material 6B and inserted in between the casing (described below). In another embodiment of the present application, the hologram lens 5 can created by using a hologram film such as diffraction grating film (See FIG. 1B, reference numeral 6A). The properties of the diffracting grating film are such that it breaks up white light into all the colors of the spectrum. In other words, the light can be split and diffracted into several beams travelling in different directions. The properties of the diffracting grating film are well known in the art and will not be further discussed. Of course, other materials and types of film can be used to create the hologram lens 5.

The inner diameter of the bracket 7 can be 1.6 cm and the outer diameter can be 3.0 cm. The diameter of the clear plastic material 6B can be 2.5 cm. The diameter of the inner hole of the casing can be 1.6 cm. Of course, other sized components and materials may be used. The hologram lens 5 fits into the aperture of the casing 4. After the hologram lens is secured within the casing, the portion housing the hologram lens may also be referred to as a “viewer” for viewing images.

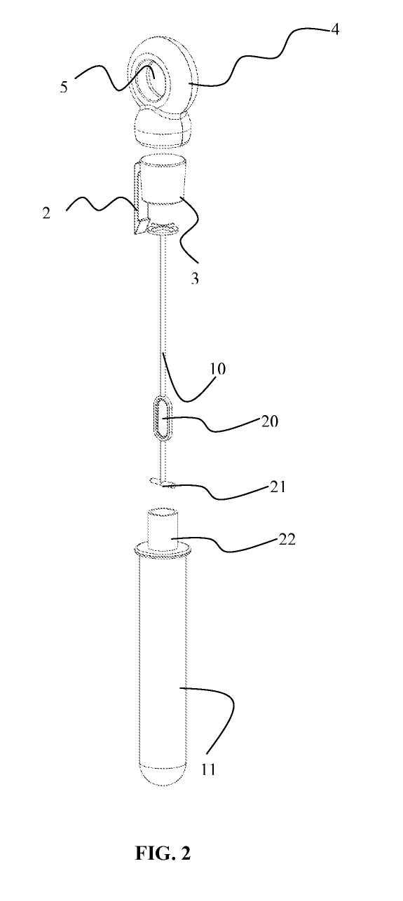

In one embodiment of the present application, the clip 2 and lid 3 are attached to each other and form one unit, as shown in FIG. 1B. Attached to the base of this unit is a T-bar wand (see FIG. 2, reference numerals 10, 20 and 21, described in detail below). Therefore, in one embodiment of the present application, the clip 2, lid 3 and the T-bar wand are attached together to form one unit. The clip 2, lid 3, the wand 10, the hologram film 6A, the clear plastic material 6B and the bracket 7 can be constructed of any reasonable material such as, but not limited to any type of plastic, and/or from any material from an animal source, plant source, mineral source, and synthetic source, and/or any other reasonable source. In one embodiment of the present application, the hologram film can be laminated to the clear plastic material 6B.

In order to construct the hologram lens cap, the clip 2 and lid 3 unit can be pushed into designated cavities in either one of the front casing 8A or the back casing 8B. Also, the bracket 7, which contains three holes for the prongs 9 to fit through, the hologram film 6A and the clear plastic material 6B are held in place and secured between the casings. When the prongs 9 are passed through the bracket 7 and are locked inside the female sections of the back casing 8B and all the components are secured, the hologram lens cap 1, as shown in FIG. 1A, can be constructed as one unit. Any adhesives or any reasonable material from an animal source, plant source, mineral source, and synthetic source, and/or any other reasonable source can be used to hold together one, many or all of the components of the hologram lens cap 1.

A wand 10 can also be affixed to the base of the clip 2 and lid 3 unit, as illustrated in FIGS. 2, 3A and 3B. The wand 10 can be fixed internally to the cap and projects down into the barrel of a capsule or container 11 holding the bubble-producing formula, for example Catch-A-Bubble®. In one embodiment of the present application, the wand can be a “T” bar 21 wand system that, in combination with a top portion 22 of the container 11 having a smaller diameter than the length of the widest portion of the “T” bar 21 wand, prevents the wand from completely being pulled out of the container. In that embodiment of the present application, the “T” bar wand system allows a child to blow bubbles through the opening of the wand 10 without allowing the child to completely pull out the wand. That is, the wand 10 in combination with a restriction at the top portion 22 of the container, can be dipped into the container 11 of solution and can be partially pulled out of the container 11, but the upside-down “T” shaped bottom 21 of the wand 10 prevents the child from being able to completely pull the wand 10 out of the container 11. In this way, the hologram lens cap 1 significantly reduces liquid dripping off the wand that usually occurs when a conventional wand is removed from the container. In one embodiment of the present application, the aperture 20 for liquid retention can be “eye” shaped. Of course, the aperture 20 may be any shape or size, without departing from the spirit or scope of the present application. Additionally, the wand 10 can be rigid or collapsible. In another embodiment of the present application, the lens cap 1 be screwed onto an appropriate section of the container 11. Of course, other means of affixing the lens cap 1 to the container such as a friction fit, is possible.

The partially assembled wand and cap are shown in FIG. 2. In a preferred embodiment of the present application, the hologram lens cap 1 includes all the pieces shown in FIGS. 2, 3A and 3B, such as the wand 10, the casing 4, the hologram lens 5, the clip 2 and the lid 3 as one unit. These pieces can be affixed to each other by any means to form a solid piece. In another embodiment, the casing 4 holding the hologram lens 5 can be separated from the lid portion containing the clip 2 and the lid 3.

FIGS. 3A and 3B illustrate in detail the unassembled portions of the hologram lens cap 1. FIG. 3B is a mirror image of FIG. 3A. As described above, these portions can be joined with one another to form the hologram lens cap 1.

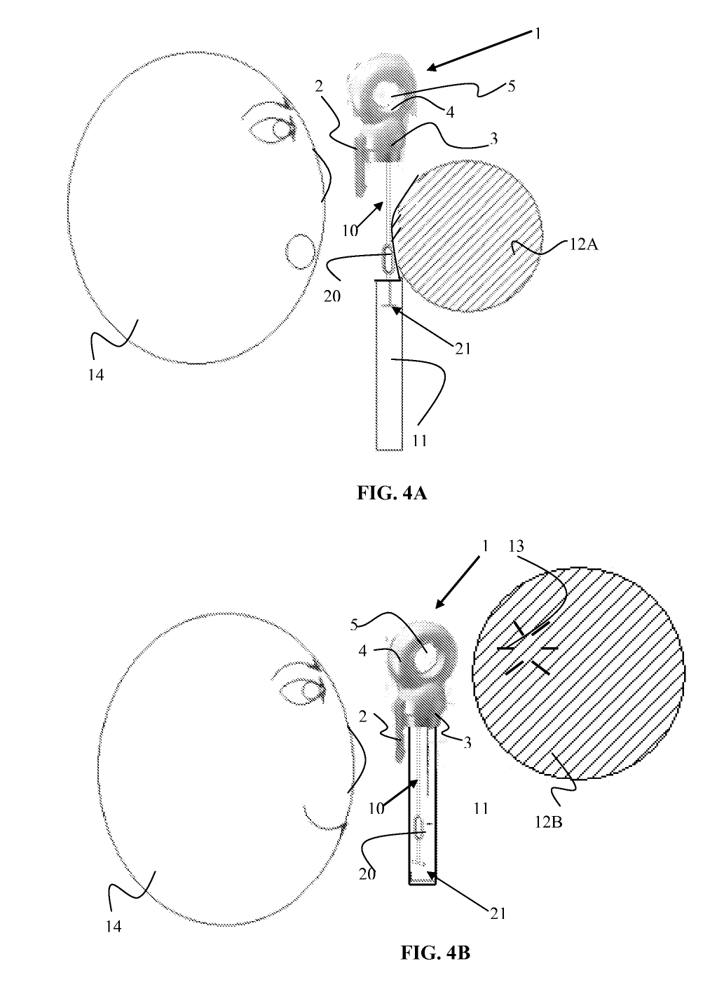

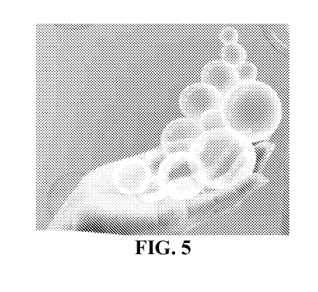

In one embodiment of the present application, the barrel of the container 11 houses a specific bubble formula, such as the Catch-A-Bubble® formula. The Catch-A-Bubble® formula is polymer based, which allows the bubble to at least partially harden on contact with air enough to permit manipulation. Therefore, the properties of this polymer-based formula and bubble can permit diffraction of light, as light can easily reflect off the bubble created by this formula. Such a formula also allows a child to blow bubbles through the aperture 20 in the wand 10 and then catch the bubbles in his/her hand, as shown in FIG. 5, because the bubbles are at least partially hardened on contact with air. In one embodiment of the present application, when the bubble is caught under sunlight or a spot light, a child holds the hologram lens cap 1 close to the bubble and views the bubble through the lens, as a result of diffraction of light reflected from the surface of the bubble, to see an apparent bubble having one or more “stars” within the bubble. That is, the diffraction grating film on the lens can split and diffract the light into its spectral components (i.e., into several beams travelling in different directions). Such an effect may appear to a child as at least one colorful “star” within the bubble. Therefore, after blowing a bubble, catching the bubble, and viewing the bubble through the hologram lens cap, the child appears to have “caught a star” in his/her bubble. The details of this process will now be described with respect to FIGS. 4A and 4B (not drawn to scale).

A child 14 can unscrew or otherwise remove the hologram lens cap 1 from the container 11. The child can then pull out the hologram lens cap 1 so that the wand 10, especially the “eye” aperture 20 portion of the “T” shaped wand 10 can be exposed. The child 14 is not able to fully separate the hologram lens cap 1 from the container as the “T” bottom 21 of the wand 10, in combination with the top portion restriction 22, prevents the wand from completely being pulled out of the barrel of the container 11. Therefore, the child 14 may unscrew the hologram lens cap 1 and rotate it any direction, but cannot completely separate the hologram lens cap 1 from the container 11. The “eye” aperture 20 portion of the wand is sufficiently exposed from the container 11 and contains a thin, continuous layer of the liquid Catch-A-Bubble® formula. This thin layer can be created as a result of the liquid within the container streaming down along the wand under the action of gravity, where the surface tension of the formulated liquid creates this layer within aperture 20. As the child 14 expels air out of his/her mouth by “blowing” into the aperture 20, the thin layer, formed from a polymer-based liquid having somewhat elastic properties, expands to produce one or more bubbles such as bubble 12A, as illustrated in FIG. 4A.

After the bubble(s) is/are created, the child 14 screws or otherwise reattaches the hologram lens cap 1 back onto the container 11. This prevents the child 14 from spilling the formula contained within the container 11 while the child is mobile. In another embodiment, the lid portion of the hologram lens cap 1 snaps onto the container 11. The hologram lens cap 1 can form a seal onto the container 11 in any known manner.

The child 14 can then run around and catch blown bubble(s) that have hardened in the air, on his/her hand, as shown in FIG. 5. Of course, the child 14 may hand the bubble to another child or place the bubble anywhere.

The child 14 can hold up the bubble(s) in front of the hologram lens cap 1 and container 11 (the hologram lens cap 1 now sealed on top of the container 11) for viewing through his/her eyes. The child may hold the bubble(s) in one hand, for example, while holding the hologram lens cap 1 attached to the container 11 in the other hand. The child can view the bubble through the hologram lens 5 viewer. In one embodiment of the present application, the hologram lens 5 viewer portion of the hologram lens cap 1 may contain a film that can be at least partially translucent, allowing the child to look through the hologram lens viewer to see the bubble.

Due to the Catch-A-Bubble® polymer-based formula, the bubble(s) reflect(s) off sunlight or bright light from a light source. The bubble(s), constructed of the specially formulated Catch-A-Bubble® polymer-based formula, can quickly air dry and at least partially harden in the atmosphere so that it may be manipulated and/or handled by the child. Of course, in an alternative embodiment, other bubble producing formula may be utilized to create these type of bubbles.

The child can position the bubble(s) in an optimal viewing position, such as approximately 5-31 cm (approximately between 2-12 inches) away from his/her head and eyes. In one embodiment of the present application, when viewing the bubble(s) through the hologram lens cap 1, the child can see the reflective light on the bubble separated into a spectrum that may appear as at least one bright, sparkling “star” 13. That is, the light being broken down and diffracted into several beams traveling in different directions comprising the spectrum can appear as several different colored “lines” bursting out, which can appear to be a “star”-like. Therefore, the child has now been able to “catch a star” within the blown bubble 12B, as shown in FIG. 4B. Of course, the lines shown in bubble 12B are for illustratively purposes only and are not meant to limit the spirit and scope of the present application.

The hologram lens cap 1 can be used to view the light spectrum of objects other than bubbles. According to an exemplary embodiment, the hologram lens cap 1 can be used to look at any light emitting diode (L.E.D.) or bright night light source. Of course, the hologram lens cap 1 can be used to view other objects that reflect light.

After the child has finished playing, the hologram lens cap 1 and the container 11 can be placed inside and secured to the child's pocket by using the clip 2.

Now that exemplary embodiments of the present disclosure have been shown and described in detail, various modifications and improvements thereon will become readily apparent to those skilled in the art.

What is claimed is:

1. A method for viewing a spectrum of light rejected off an object through a lens comprising:
generating and at least partially immobilizing the object;
exposing at least part of the object to light, wherein the object at least partially reflects the light; and
viewing at least part of the object through the lens, wherein the lens separates at least some of the light reflected off the object into the spectrum.

2. The method of claim 1, wherein the object is a bubble.

3. The method of claim 2, wherein the bubble is formulated using a polymer-based solution.

4. A method of viewing an object through a lens, the object formed from liquid housed within a capsule having a top portion and a bottom portion comprising:
separating at least part of the top portion of the capsule from at least part of the bottom portion of the capsule;
generating the object from the liquid, the object having a substantially spherical shape;
rejoining the at least part of the top portion of the capsule with the at least part of the bottom portion of the capsule; and
viewing the object through the lens, the lens comprising a film, wherein the lens being housed on the top portion, and wherein at least part of the object is exposed to a light.

5. The method of claim 4 wherein a distance between the object and the lens is between 2 inches to 12 inches.

6. The method of claim 4 wherein the object is a bubble.

7. The method of claim 6 wherein the bubble is formulated using a polymer-based solution.

8. A system of viewing an object through a lens comprising:
a capsule housing a liquid, the capsule comprising:
a top portion including a wand and a casing having an aperture, wherein the aperture houses the lens comprising a film; and
a bottom portion, the top portion and bottom portion adapted to be at least partially separated from each other; and
the object, generated by the liquid being inserted through the wand, wherein the generated object is capable of manual manipulation;
wherein upon placing the object adjacent to the aperture housing the lens, the object is adapted to be viewed through the lens.

9. The system of claim 8 wherein the liquid is polymer-based.

10. The system of claim 8 wherein the object is adapted to be at least partially immobilized.

11. The system of claim 8 wherein the viewing of the object through the lens generates a spectrum.

12. The system of claim 11 wherein the spectrum is generated when at least part of the object is exposed to a light.

13. The system of claim 8 wherein the object is a bubble.

14. The system of claim 8 herein a distance between the object and the aperture housing the lens is between 2 inches to 12 inches.

15. The system of claim 8 wherein the wand and the aperture housing the lens are coupled to each other.

16. The system of claim 13 wherein the bubble is partially immobilized and can rest on a surface.

17. An apparatus for viewing a spectrum through a lens attached to a container comprising:
a cap comprising:
the lens comprising a hologram film; and
a casing for securing the hologram film; and
a wand comprising an aperture, the wand coupled to the cap and the wand at least removably secured within the container;
polymer based bubble solution within the container, wherein after an object is generated by blowing on the polymer based bubble solution entrapped in the aperture of the wand, the cap is held in proximity of the object such that when the object is viewed through the lens of the cap, a spectrum is viewable.

18. The apparatus of claim 17 wherein the object is a bubble.
